(19) United States
(12) Patent Application Publication
(10) Pub. No.: US 2014/0109475 A1
(43) Pub. Date: Apr. 24, 2014

(54) Method of Cultivating Labisia Pumila Plants in Oil Palm Plantation

(71) Applicant: Pharmaniaga Berhad, Shah Alam (MY)

(72) Inventors: Miau Ching Ho, Shah Alam (MY); Mohd Haris Fadella bin Ishak, Shah Alam (MY); Ahmad bin Hashim, Shah Alam (MY)

(73) Assignee: PHARMANIAGA BERHAD, Shah Alam (MY)

(21) Appl. No.: 14/039,152

(22) Filed: Sep. 27, 2013

(30) Foreign Application Priority Data
Oct. 24, 2012 (MY) PI 2012004717

(51) Int. Cl. A01G 1/00

(52) U.S. Cl. CPC A01G 1/001
USPC 47/58.1 R

(57) ABSTRACT

An improved method of cultivating Labisia pumila plants in oil palm plantation comprising the steps of propagating Labisia pumila plants using leaf cuttings, hardening propagated Labisia pumila plants and cultivating Labisia pumila plants in planting beds between alternate rows of the oil palm trees, characterized in that the oil palm plantation is more than fifteen years old and the land is flat and undulating, not prone to water logging, having pH 4.5 to pH 5.5 of soil acidity, soil type preferably Siri Tawar and has stopped using chemical-based agents not limited to herbicides and pesticides.

### BACKGROUND OF THE INVENTION

1. Field of the Invention

The present invention relates to a method of cultivating herbal plant in an oil palm plantation, and more particularly to an improved method of cultivating Labisia pumila plants through vegetative reproduction using leaf cuttings and controlled parameters to cultivate the plant in an oil palm plantation.

2. Description of Related Arts

Labisia pumila or locally known as Kacip Fatimah is generally a wild herbal plant that lives in tropical rainforests. Labisia pumila plants are normally found in Indochina and throughout Malaysia, Sumatera, Java, Borneo and Thailand, Labisia pumila is an under-storey plant of primary and old secondary forest where the plant grows naturally in low land to hill forest on soil rich with humus and heavily shaded area. The plant is naturally propagated by seed.

Labisia pumila has long been used by the Malays and natives as traditional medicine for women. It is mainly used by women after childbirth to firm and tone the muscles, as a health tonic to increase energy, improve blood circulation, and relieve feminine problems and for general health. There is an increased demand for Labisia pumila plants due to its medicinal properties. Massive harvesting of wild Labisia pumila plant from forests has resulted in a decline in its quantity. In order to preserve the rainforests from such uncontrolled harvesting of Labisia pumila plants which may eventually damage the ecosystem, a viable method to cultivate the Labisia pumila plants in a suitable controlled environment is needed. An improved method of cultivating Labisia pumila plants is important to ensure sustainability of this plant for future use.

In order for the Labisia pumila plants to grow well; an ideal condition is required for healthy plant multiplication; for example an ideal soil pH, sufficient amount of nutrients, water and adequate growth temperature.

A publication available in the public domain has disclosed an integration of Labisia pumila with oil palm. It is briefly described in the publication that the plants can be planted in an oil palm plantation, utilising the abundant of space in between the oil palms. The planting is said to be confined in the water inter-row spaces at specific distances from the palm rows to avoid competition of nutrients amongst the plants. This publication disclosed the general concept of Labisia pumila plant cultivation in oil palm plantation. The cultivation method introduced by the present invention has numerous technical advantages in cultivating the Labisia pumila plants for commercial purpose to ensure sustainable source of the plants. The cultivation method introduced by the present invention includes preparation of planting beds with specific configuration, cultivating Labisia pumila plants in planting beds between alternate rows of the oil palm trees, applying organic fertilizer with specific nutrient ratio, maintaining the plants growth and etc. These parameters introduced by the present invention improve the growth and quality of Labisia pumila plants cultivation in oil palm plantation.

Accordingly, it can be seen from the prior art that there exists a need to provide an improvement towards the cultivation method of Labisia pumila plants. The present invention introduces more practical, organically grown Labisia pumila plants and applying controlled parameters that results in high quality and high yield of Labisia pumila plants for mass production.

### SUMMARY OF INVENTION

The present invention aims to provide an improved method of cultivating Labisia pumila plants through vegetative reproduction using leaf cuttings and controlled parameters to cultivate the plant in an oil palm plantation.

In a preferred embodiment of the present invention, an improved method of cultivating Labisia pumila plants in oil palm plantation comprising the steps of propagating Labisia pumila plants using leaf cuttings, hardening of propagated Labisia pumila plants and cultivating Labisia pumila plants in planting beds between alternate rows of the oil palm trees characterized in that the oil palm plantation is more than fifteen years old and the and is flat and undulating, not prone to water logging, having pH 4.5 to pH 5.5 of soil acidity, soil type preferably Siri Tawar and has stopped using chemical-based agents not limited to herbicides and pesticides. The oil palm plantation is suitable for Labisia pumila plants cultivation because it mimics the natural habitat of Labisia pumila plants and provides a good shading area as the plants are sensitive to sunlight exposures.

In another preferred embodiment of the present invention, a healthy wild plant material with good leaves foliage, disease and pest free is selected as the starting material for propagating and cultivating Labisia pumila plant.

In another preferred embodiment of the present invention, Labisia pumila plants are propagated using leaf cuttings in a non-mist system. The rooted leaf cuttings are potted in polybags and transferred to a shade house for hardening purpose. After hardening process, the young Labisia pumila plants are transferred into the planting beds for cultivation.

In another preferred embodiment of the present invention, the cultivation process includes constructing planting beds between alternate rows of the oil palm trees.

In another preferred embodiment of the present invention, the planting beds are constructed according to cluster/island type configuration.

In another preferred embodiment of the present invention, the cluster/island type of planting beds is configured in groups.

In another preferred embodiment of the present invention, organic fertilizer is introduced into each planting holes prior to transferring the hardened young Labisia pumila plant material into the planting holes for cultivation process.

In another preferred embodiment of the present invention, the organic fertilizer is made of composted oil palm leaves, fruits, vegetables and cow dungs. The fertilizers are applied at least three times a month to the cultivated plants to encourage plants growth.

In another preferred embodiment of the present invention, the organic fertilizer preferably ranging from 0.1% to 0.6% Nitrogen, 0.1% to 0.4% Phosphorus and 0.8% to 1.5% Potassium.

In another preferred embodiment of the present invention, the cultivated Labisia pumila plants are watered at least twice a day to ensure optimum growth.

In another preferred embodiment of the present invention, the cultivated Labisia pumila plants may be harvested within seven to nine months.

### BRIEF DESCRIPTION OF THE DRAWINGS

The features of the invention will be more readily understood and appreciated from the following detailed description when read in conjunction with the accompanying drawings of the preferred embodiment of the present invention, in which:

FIG. 1 shows a flow chart of an improved method to cultivate Labisia pumila plants in oil palm plantations (100).

FIG. 2 shows planting bed configuration for the cultivation of Labisia Pumila plants (200).

### DETAILED DESCRIPTION OF THE INVENTION

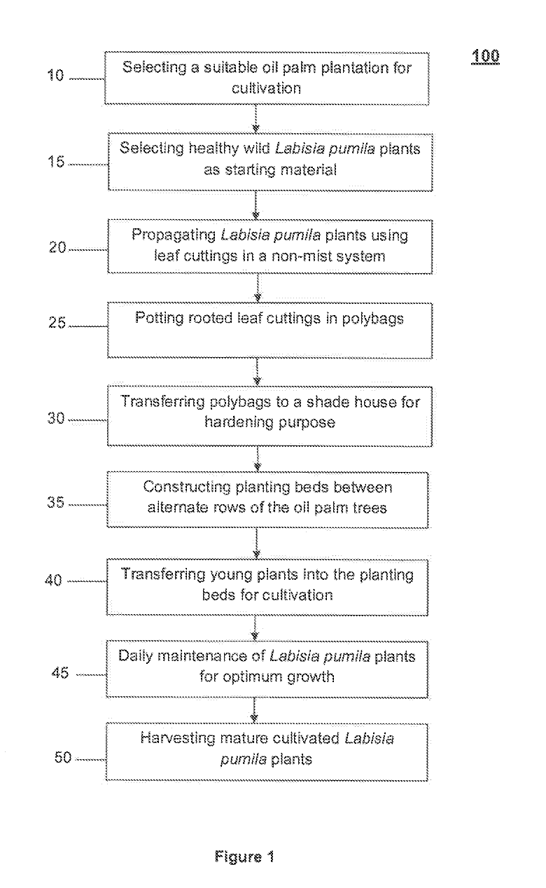

As required, detailed embodiments of the present invention are disclosed herein: however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modification, equivalents and alternatives falling within the scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or an mean at least one and the word “plurality” means one or more, unless otherwise mentioned. Where the abbreviations of technical terms are used, these indicate the commonly accepted meanings as known in the technical field. For ease of reference, common reference numerals will be used throughout the figures when referring to the same or similar features common to the figures. The present invention will now be described with reference to FIG. 1.

FIG. 1 shows a flow chart of the improved method to cultivate Labisia pumila plants in oil palm plantation (100). Prior to the process of cultivation, a suitable oil palm plantation is selected (10) in order to cultivate the Labisia pumila plants. The oil palm plantation is preferably of more than fifteen years old and has stopped using chemical-based agents such as herbicides and/or pesticides. The land selected for the plant cultivation is preferably flat or undulating and not prone to water logging. Further to that, the soil is preferably ranging from pH4.5 to 5.5, soil type preferably Siri Tawar and humus rich for better plants growth.

The oil palm plantation provides sufficient shading for the Labisia pumila plants to grow as the plants are sensitive to sunlight exposures. Alternatively, artificial shades may also be applied in order to provide stable and continuous shading to the heat-sensitive Labisia pumila plants. The oil palm plantation has plenty of spaces between the rows of oil palm trees to construct planting beds for the plant cultivation. A good drainage and irrigation system in the oil palm plantation is important in order to ensure continuous water supply for the plant growth.

Prior to the cultivation process of Labisia pumila plants, the soil is tilled twice wherein during the first round of tilling, soil between alternate oil palm trees are turned and ploughed. The unploughed rows are used as maintenance rows for tending to fronds. The second round of tilling is conducted at two to three days earlier prior to the construction of planting beds to ensure proper aeration and mixing,

The propagation of Labisia pumila is conducted by selecting healthy wild plant materials with good leaves foliage, disease and pest free as starting material (15).

Labisia pumila plants are thereafter propagated using leaf cuttings in a non-mist system (20). The rooted leaf cuttings are potted in polybags (25) and transferred to a shade house for hardening purpose (30). Planting beds are constructed between alternate rows of the oil palm trees (35). After the said hardening process, young Labisia pumila plants are transferred into the planting beds (40) for the purpose of cultivation.

The plants are watered at least twice a day to ensure healthy plant growth. Organic fertilizers are applied at least three times a month to ensure sufficient amount of nutrients are supplied to the Labisia pumila plants for optimum growth.

The organic fertilizers are made of composted oil palm leaves, fruits, vegetables and caw dungs. The composition of organic fertilizers preferably ranging from 0.1 to 0.6% Nitrogen, 0.1 to 0.4% Phosphorus and 0.8 to 1.5% Potassium. There are no chemical based fertilizers used in the cultivation of Labisia pumila plants.

The maintenance of the plants is conducted regularly to ensure optimum growth of the plants (45). The plants maintenance are carried out by removing spoiled leaves and/or disease infected plant and/or leaves while minute plants are kept to mimic the natural growth habitat of the Labisia pumila plants.

After seven to nine months of cultivation, the cultivated Labisia pumila plants are mature and ready for harvesting (50).

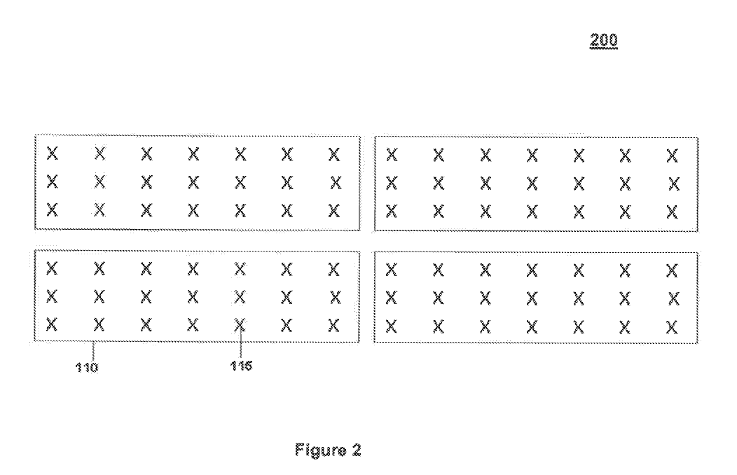

For cultivation purpose, the planting beds are constructed according to cluster or island type of configuration as shown in FIG. 2 (110). The planting holes (115) are made parallel to each other in straight lines. This particular configuration increases the number of Labisia pumila plants to be cultivated by optimizing the spaces available and allows ease of maintenance of the planting bed.

Although the present invention has been described above with respect to various presently preferred embodiments, it will be apparent to one of ordinary skill in the art that many variations and modifications may be made. Therefore, the invention is not to be understood as limited to the particular embodiments recited herein but, rather is to be understood as embracing all such variations and modifications which fall within the scope of the claims appended hereto.

I/We claim:

1. An improved method of cultivating Labisia pumila plants in oil palm plantation comprising the steps of:
cultivating Labisia pumila plants in planting beds between alternate rows of the oil palm trees;
characterized in that the oil palm plantation is more than fifteen years old and the and is flat and undulating, not prone to water logging, having pH 4.5 to pH 5.5 of soil acidity, soil type preferably Siri Tawar and has stopped using chemical-based agents not limited to herbicides and pesticides.

2. The method according to claim 1, characterized in that healthy wild plant material with good leaves foliage, disease and pest free is selected as the starting material for propagating and cultivating Labisia pumila plant.

3. The method according to claim 1, characterized in that the cultivation process includes constructing planting beds between alternate rows of the oil palm trees.

4. The method according to claim 3, characterized in that each planting bed is constructed according to cluster/island type of configuration.

5. The method according to claim 3, characterized in that the cluster/island type of planting beds are configured in groups.

6. The method according to claim 1, characterized in that organic fertilizer is introduced into each planting holes prior to transferring of hardened plant materials, into the planting holes for cultivation process.

7. The method according to claim 6, the organic fertilizer is made of composted oil palm leaves, fruits, vegetables and cow dungs and the fertilizers are applied at least three times a month to the cultivated plants to encourage plants growth.

8. The method according to claim 7, characterized in that the organic fertilizer preferably ranging from 0.1% to 0.6% Nitrogen, 0.1% to 0.4% Phosphorus and 0.8% to 1.5% Potassium.

9. The method according to claim 1, characterized in that the cultivated plants is watered at least twice a day to ensure optimum growth.

10. The method according to claim 1, characterized in that the cultivated Labisia pumila plants may be harvested within seven to nine months.
